(19) United States
(12) Patent Application Publication
(10) Pub. No.: US 2004/0125051 A1
(43) Pub. Date: Jul. 1, 2004

(54) Method for driving plasma display panel and plasma display device

(75) Inventors: Hitoshi Hirakawa, Kawasaki (JP); Shinsuke Tanaka, Kawasaki (JP); Takashi Shiizaki, Kawasaki (JP); Satoru Nishimura, Kawasaki (JP); Yoshikazu Kanazawa, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU HITACHI PLASMA DISPLAY LIMITED, Kawasaki (JP)

(21) Appl. No.: 10/661,535

(22) Filed: Sep. 15, 2003

(30) Foreign Application Priority Data
Dec. 27, 2002 (JP) 2002-380904

(51) Int. Cl. G09G 3/28

(52) U.S. Cl. 345/63

(57) ABSTRACT

A method for driving a plasma display panel, wherein a display field, corresponding to a display of a screen, is composed of a plurality of subfields, a gradation display is realized by combining subfields to be lit among the plurality of subfields, cells to be lit in the display field are separated from unlit cells and all of the cells to be lit are lit in a predetermined subfield arranged near the head in the display field. The gradation display level is set with the light emission in the predetermined subfield being taken into consideration.

### BACKGROUND OF THE INVENTION

The present invention relates to a method for driving a plasma display panel (PDP) and a PDP device. More particularly, the present invention relates to a driving method that improves the display contrast of a PDP.

FIG. 1 is a diagram showing a basic configuration of a PDP device.

A plasma display panel (PDP) 1 is a device in which a discharge space sandwiched by two glass substrates filled up with a mixture of neon gas, xenon gas, etc., a discharge is occurred by applying a voltage greater than a discharge start voltage between electrodes formed on the substrate, and phosphors formed on the substrate are excited so that they emit light due to ultraviolet rays generated by the discharge. Although various configurations have been proposed for a PDP, an AC type/three-electrode surface discharge type panel, which is currently most widely used, is described as an example.

In the plasma display panel (PDP) 1, a plurality of X electrodes (sustain electrode) 2 and a plurality of Y electrodes (scan electrode) 3 are arranged adjacently by turn and a plurality of address electrodes (third electrodes) 4 are arranged in the direction perpendicular to that in which the X electrodes and the Y electrodes extend. Between a pair of X electrode and Y electrode, that is, between X1 and Y1, between X2 and Y2, . . . , a display line is formed and a display cell 5 is formed at the crossing of each display line and the address electrode 4. The X electrodes and the Y electrodes are referred to as the display electrodes.

The X electrodes are commonly connected to an X drive circuit 7 and the same drive signal is applied all to them. The X drive circuit 7 is provided with a sustain pulse circuit 8 that generates a sustain pulse, and a reset/address voltage generation circuit 9 that generates a voltage used during the reset and address operations, both of which will be described later. The Y electrodes are connected individually to a scan circuit 11 provided within a Y drive circuit 10, and a scan pulse is applied sequentially to them during an address period which will be described later. The Y drive circuit 10 is further provided with a sustain pulse circuit 12 that generates a sustain pulse, and a reset/address voltage generation circuit 13 that generates a reset/address voltage. The address electrodes are connected to an address driver 6 and an address signal to select a cell to be lit or not to be lit is applied to them during the address operation in synchronization with the scan pulse.

As a discharge in a PDP takes only two values, that is, ON and OFF, gradation is displayed by varying the number of times of light emission. Therefore, one display field that corresponds to a display of a screen is divided into a plurality of subfields. Each subfield is composed of a reset period, an address period and a sustain discharge period (sustain period). During the reset period, the reset operation is performed so that all of the display cells are put into a uniform state in which, for example, wall charges are erased, or wall charges are formed uniformly, regardless of the lit or unlit state of the cells in the previous subfield. During the address period, a selective discharge (address discharge) is caused to occur so that the ON (lit) or OFF (unlit) state of a display cell is determined according to display data and the wall charges in a cell to be lit are put into a state different from that of a cell not to be lit. During the sustain period, a discharge is caused to occur repeatedly in a display cell selected during the address period and light is emitted. If the number of sustain discharge pulses, that is, the period of the sustain discharge pulse, is constant, the length of the sustain discharge period differs from subfield to subfield, therefore gradation can be displayed by setting the ratio of times of light emission in each subfield to, for example, 1:2:4:8: . . . , and combining subfields that are to emit light according to the gradation of each display cell.

FIG. 3 is a diagram that shows typical examples of drive waveforms in each subfield of a conventional PDP device. As shown schematically, during the reset period, in a state in which 0V is being applied to an address electrode A, an inclined wave-shaped pulse m, the voltage of which varies gradually from 0V to Vs+Vw, is applied to the Y electrode, and an inclined wave-shaped pulse, the voltage of which gradually varies from 0V to −Vs, is applied to the X electrode. Due to this, a discharge is caused to occur in all of the cells regardless of the wall charges accumulated in the display cell, and negative wall charges are accumulated on the Y electrode and the positive charges, on the X electrode. This is called the all-cell write discharge (reset discharge). Subsequently to this, an inclined wave-shaped charge control pulse n, the voltage of which drops gradually from Vs, is applied to the Y electrode and a voltage Vs is applied to the X electrode, therefore, the wall charges accumulated in the Y electrode and X electrode by the write discharge decrease almost to zero. Although a description is given below using an example of an inclined wave-shaped pulse, the voltage of which varies linearly, it is possible for there to be a case where the voltage does not vary linearly.

During the address period, the voltage Vx is applied to the X electrode and, in a state in which 0V is being applied to the Y electrode, a scan pulse having a voltage −Vs−Vy is applied sequentially to the Y electrode and an address voltage Va is applied to the address electrode A in a cell to be lit in synchronization with the application of the scan pulse. The voltage 0V is applied to the address electrode in a cell not to be lit. An address discharge is caused to occur in a cell to be lit to which the scan pulse and the address voltage have been applied, and positive wall charges are accumulated in the Y electrode and negative charges are accumulated in the X electrode. In this case, the quantities of these wall charges in the Y electrode and X electrode are sufficient to cause a sustain discharge to occur when a sustain discharge pulse is applied. As an address discharge is not caused to occur in a cell not to be lit, the quantities of wall charges in the Y electrode and X electrode are made to remain almost zero.

During the sustain discharge period, in a state in which 0V is being applied to the address electrode, the voltage Vs and the voltage −Vs are applied alternately to the X electrode and Y electrode as a sustain pulse. The voltage of the sustain pulse to be applied to the Y electrode for the first time is set to Vs+Vu. In a cell to be lit, the voltage due to wall charges is added to the voltage of the sustain pulse, the discharge start voltage is exceeded and a sustain discharge is caused to occur, and the charges move and a quantity of charges necessary for the next sustain discharge are accumulated in the Y electrode and X electrode. In other words, when the address period is completed, positive wall charges are accumulated in the Y electrode and negative wall charges are accumulated in the X electrode, that is, a voltage, the high potential side of which is the Y electrode, is applied between the Y electrode and the X electrode. Therefore, if the voltage Vs+Vu is applied to the Y electrode as a sustain pulse and −Vs is applied to the X electrode at the inception of the sustain period, the voltage due to the above-mentioned wall charges is added so that the discharge start voltage is exceeded, and a sustain discharge is caused to occur. When a sustain discharge is caused to occur, the positive charges move from the Y electrode to the X electrode and accumulate therein, the negative charges move from the X electrode to the Y electrode and accumulate therein, and the sustain discharge is terminated because a voltage, the high potential side of which is the X electrode, is produced by the movement of charges. Then, if −Vs is applied to the Y electrode as a sustain pulse and the voltage Vs is applied to the X electrode, a sustain discharge is caused to occur because the voltage due to the wall charges, the high potential side of which is the x electrode, is added. This cycle is repeated during the sustain period. As no charge is accumulated in a cell not to be lit, no discharge is caused to occur even though a sustain pulse is applied to either electrode.

Each subfield has a structure as described above, but the length of the sustain period, that is, the number of sustain pulses, differs according to the weights of luminance in each subfield. A desired gradation can be displayed by combining subfields to be lit from among ten subfields.

FIG. 4 is a diagram that shows an example of gradation display in a conventional PDP device. In this example, one display field is composed of ten subfields SF1-SF10 and each subfield has a luminance ratio as shown schematically. At the head of the one display field, SF1 with the lowest luminance ratio is arranged and following this, the subfields each having each luminance ratio shown schematically are arranged in order. When each gradation level is displayed, subfields to be lit are combined as shown schematically. Although only the gradation levels 0 to 35 are shown here, it is possible to display up to 124 gradation levels in this example. Moreover, in this example, by providing subfields having the same luminance ratio in twos for the four kinds of luminance ratios, it is possible for there to be multiple combinations for the display of the same gradation level. Due to this, a color false contour can be reduced.

A description has been given of the conventionally typical PDP device as above, but it is possible for there to be various methods for the PDP device. For example, Japanese Unexamined Patent Publication (Kokai) No. 9-160525 has disclosed a PDP device in which the number of display lines is doubled while the number of sustain electrodes remains the same as conventionally, by utilizing all the gaps between neighboring sustain electrodes as a display cell. Although it is possible to apply the present invention to any PDP device as long as it displays gradation using the subfield method, no further description is given here.

In an AC type PDP device, the quantity or the state of accumulated wall charges in a cell after the sustain period differs between a cell to be lit and one not to be lit. Therefore, there is a problem that the address discharge in the subsequent subfield becomes unstable and it is difficult to ensure a sufficient operation margin. In an AC type PDP device, therefore, the all-cell write discharge (reset discharge) is caused to occur during the reset period in each subfield as described above, and the wall charges in each cell are brought into a uniform state. However, as the all-cell write discharge is caused to occur in all of the cells, even a cell not to be lit is made to light and as a result, a problem occurs that the background luminance becomes high and the contrast ratio is lowered significantly.

Therefore, there have been proposed various driving methods for improving the contrast ratio.

Japanese Unexamined Patent Publication (Kokai) No. 2000-75835 has disclosed a driving method for improving the contrast ratio in which the intensity of discharge during the reset period is reduced by using a pulse to be applied to the Y electrode during the reset period, which is wave-shaped and the voltage of which varies gradually.

Japanese Unexamined Patent Publication (Kokai) No. 5-313598 has disclosed a driving method in which the all-cell write discharge is caused to occur only in the subfield at the head in a display field and the all-cell write discharge is not caused to occur in other subfields. Due to this, the contrast ratio is improved because the number of times the all-cell write discharge is caused to occur is reduced.

Japanese Unexamined Patent Publication (Kokai) No. 3-219286 has disclosed a driving method in which a preliminary discharge subfield is provided and a preliminary discharge is caused to occur in all of the cells.

Japanese Unexamined Patent Publication (Kokai) No. 2002-72961 has disclosed a driving method in which a subfield for resetting is provided at the head in a display subfield and a reset discharge is caused to occur in the subfield for resetting for a cell that is to emit light.

The most effective driving method for improving the contrast ratio among the prior arts is that which has been disclosed in Japanese Unexamined Patent Publication (Kokai) No. 2000-75835, in which a reset discharge (all-cell write discharge) is caused to occur only in the subfield at the head and it is not caused to occur in other subfields. However, this driving method has the following problems.

(1) When the all-cell write discharge is caused to occur only in the subfield at the head, it is necessary to raise the write voltage to greater than that used in a case where a reset discharge is caused to occur in all of the subfields because the time interval from this discharge until the address discharge is lengthened in subsequent subfields, therefore, the cost of a drive circuit is raised, the amount of increment in the background luminance due to one reset discharge becomes large, and the contrast ratio is not reduced sufficiently.

(2) In the second and subsequent subfields, wall charges formed by the sustain discharge are formed in a cell that has been lit in the previous subfield but, in an unlit cell, only wall charges formed by the reset discharge in the subfield at the head are formed and, therefore, the states of wall charges are different. Due to this, if an address discharge is caused to occur in these states, a problem occurs that the address discharge becomes unstable in some cells and it is difficult to ensure the operation margin.

(3) Although an address discharge is caused to occur in each subfield by utilizing the wall charges formed by the reset discharge caused to occur in the subfield at the head, the priming effect diminishes in a cell where an unlit subfield follows another because the time interval, from the formation of the wall charges in the subfield at the head until they are utilized, is lengthened. Therefore, in a cell that is lit for the first time in a subfield near the end, a problem occurs that it is unlikely that the address discharge is caused to occur normally. Moreover, it is necessary to raise the address voltage in order to solve this problem, and as a result, the cost of the drive circuit is increased.

(4) A sustain discharge exerts influence also on the surrounding unlit cells through the discharge diffusion. Therefore, it is difficult to maintain the wall charges in the unlit cells formed by the reset discharge in the subfield at the head, and the next reset discharge is affected. Therefore, it is necessary to widen the reverse slit by increase the distance between neighboring cells or to design so that a partition (rib) is provided between cells, but this will degrade the display luminance of the panel. Moreover, it is impossible to widen the reverse slit in the case of the ALIS method disclosed in the above-mentioned Japanese Unexamined Paten Publication (Kokai) No. 9-160525, in which all of the spaces between sustain electrodes are used as a cell.

Because of the above-mentioned problems, it is, therefore, difficult to apply the driving method, in which a reset discharge is caused to occur only in the subfield at the head, to a high-resolution PDP device in which the reverse slit cannot be widened. Moreover, a PDP device having a box rib structure is free from the above-mentioned problems (3) and (4), but it is necessary to raise the write voltage because cells are enclosed by ribs and completely separate from each other, therefore, the cost of the drive circuit is increased.

### SUMMARY OF THE INVENTION

The object of the present invention is to realize a driving method able to realize a high-contrast PDP device that is free from the above-mentioned problems.

In order to realize the above-mentioned object, the method for driving a plasma display panel according to the present invention is characterized in that cells to be lit are separated from cells not to be lit in a display field and all of the cells to be lit are lit in a predetermined subfield arranged at a position near the head in the display field. The gradation level is set with the light emission in the predetermined subfield being taken into consideration.

FIG. 5 is a diagram that illustrates the principle of the present invention. It is assumed that subfields SF1, SF2, SF3, SF4, . . . , are arranged in this order in a display field. Conventionally, each subfield is combined to display a predetermined gradation level, and in some cases, a cell that is not lit in the subfield SF1 at the head is lit in a subsequent subfield. Contrary to this, in the configuration according to the present invention, whenever there is a subfield to be lit in a display field, it is always lit in the subfield SF1 at the head. A reset discharge is caused to occur only in a predetermined subfield and not in other subfields, but it is possible for there to be a modification such as that a reset discharge is caused to occur in a subfield with a large luminance ratio, as will be described later. Due to this, the contrast ratio can be improved similar to the conventional case where a reset discharge is caused to occur only in the subfield at the head and the following advantages can be expected.

(1) As the wall charges formed by a sustain discharge are more stable than those formed by a reset discharge (write discharge), the above-mentioned problems relating to the prior art do not occur. For example, when a cell is lit in a subfield after the predetermined subfield, a high write voltage (reset voltage) is not required because a cell in which an address discharge is caused to occur uses the wall charges formed by a sustain discharge.

In the conventional case shown in FIG. 5, for example, the cell in the fourth row and second column is lit in SF4 for the first time. Therefore, the wall charges formed by the reset discharge in SF1 are used. Contrary to this, in the present invention, the cell in the fourth row and second column has been lit in SF1 and when it is lit in SF4, the wall charges formed by the sustain discharge are used.

(2) Because the lit cells are completely separated from the unlit cells in a display field, it is possible to bring wall charges into a desired state, individually, by a proper process and to ensure an operation margin for a stable operation.

(3) Both the priming effects of the write discharge (reset discharge) and the sustain discharge can be used.

As described above, the method for driving a plasma display panel according to the present invention can improve the contrast ratio as the conventional driving method can do and at the same time, it can solve the problems relating to the prior art.

A fixed subfield is, for example, a subfield with the lowest luminance ratio, and in this case, the predetermined subfield is arranged at the head. It is also possible to arrange a subfield with the lowest luminance ratio at the head and a subfield with the second lowest luminance ratio at the second position, and use the second subfield as a fixed subfield, and thus there can be various modifications.

It is desirable to provide, in addition to a predetermined subfield, a subfield having the same luminance ratio as the predetermined subfield in a display field. Due to this, if, for example, the subfield with the lowest luminance ratio is the predetermined subfield, it is possible to display any gradation level by combining the subfields which light the predetermined subfield.

In the predetermined subfield, it is desirable to provide a reset period, during which the all-cell write discharge is caused to occur, before an address period. It is also desirable to provide a reset period, during which the all-cell write discharge is caused to occur, before an address period, not only in the predetermined subfield but also in a subfield with a heavy weight of luminance. Moreover, when the predetermined subfield is arranged at the second position, it is desirable to provide a reset period in the subfield at the head with the lowest luminance ratio. It is not necessary to provide a reset period in other subfields. During the reset period, the all-cell write discharge can be caused to occur twice or more successively.

It is desirable to cause a subfield reset discharge to occur to erase the residual charges in a lit cell in a subfield immediately before a subfield having a reset period.

In the predetermined subfield, it is desirable to widen the width of the address pulse in the address period so that the width is wider than that of the address pulse in other subfields, to raise the voltage of the address pulse so that the voltage is greater than that of the address pulse in other subfields, or to raise the voltage of the scan pulse so that the voltage is greater than that of the scan pulse in other subfields.

Moreover, in the predetermined subfield, it is desirable to perform a process to suppress the discharge in an unlit cell between the address period and the sustain period. This process is, for example, a process in which an address pulse is applied to the address electrode and at the same time, an inclined wave-shaped pulse is applied to the scan electrode. In this case, the final potential of the inclined wave-shaped pulse is set so as to be lower than the finally reached potential of an inclined wave-shaped charge control pulse during the reset period.

### BRIEF DESCRIPTION OF THE DRAWINGS

The features and advantages of the present invention will be more clearly understood from the following description taken in conjunction with the accompanying drawings in which:

FIG. 1 is a general configuration diagram of a plasma display (PDP) device;

FIG. 2 is a diagram that shows the configuration of a display field according to the subfield method;

FIG. 3 is a diagram that shows examples of conventional drive waveforms;

FIG. 4 is a diagram that shows the combination of subfields for a conventional gradation display;

FIG. 5 is a diagram that illustrates the principle of the present invention;

FIG. 6 is diagram that shows the combination of subfields for a gradation display in a first embodiment of the present invention;

FIG. 7 is a diagram that shows drive waveforms in SF1 and SF2 in the first embodiment;

FIG. 8 is a diagram that shows the combination of subfields for a gradation display in a second embodiment of the present invention;

FIG. 9 is a diagram that shows drive waveforms in SF1, SF2 and SF3 in the second embodiment;

FIG. 10 is a diagram that shows a modification of the drive waveforms in the first embodiment; and

FIG. 11 is a diagram that shows another modification of the drive waveforms in the first embodiment.

### DESCRIPTION OF THE PREFERRED EMBODIMENTS

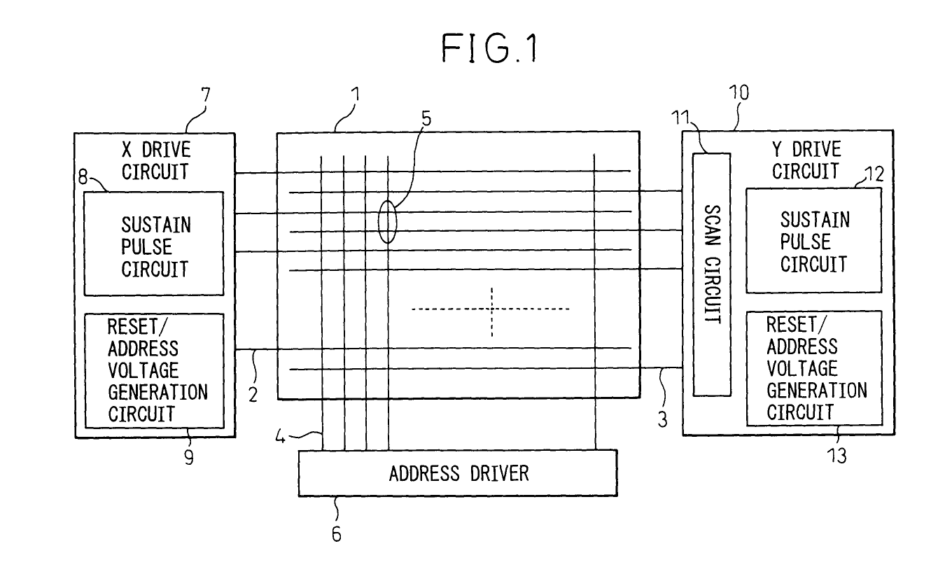

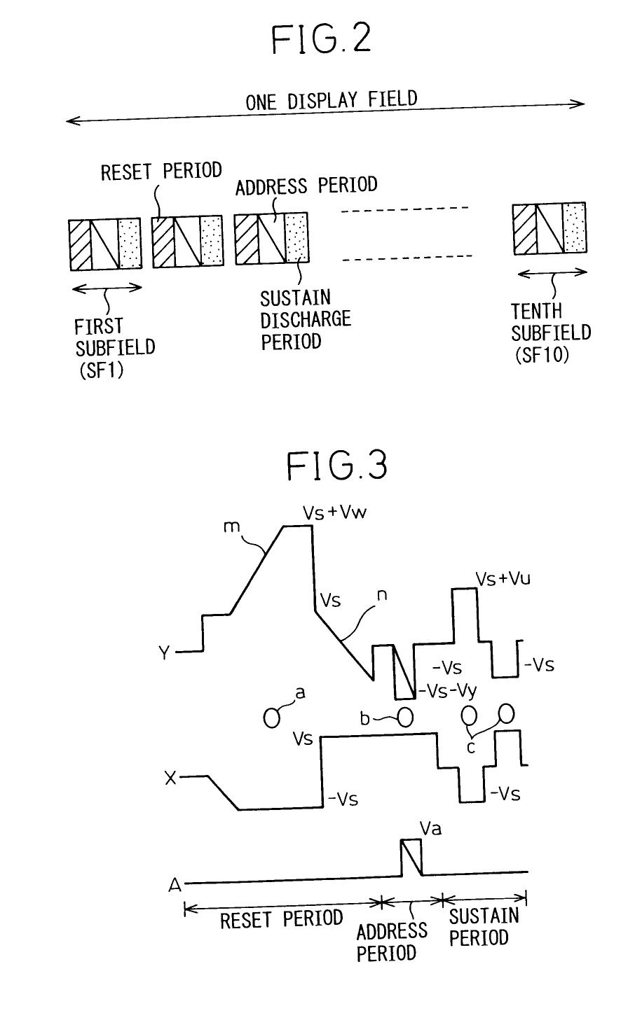

The PDP device in the embodiments of the present invention has a configuration as shown in FIG. 1. However, the present invention is not limited to this, but can be applied to any PDP device as long as it realizes gradation display by the subfield method, for example, the PDP device using the ALIS method disclosed in Japanese Unexamined Patent Publication (Kokai) No. 9-160525.

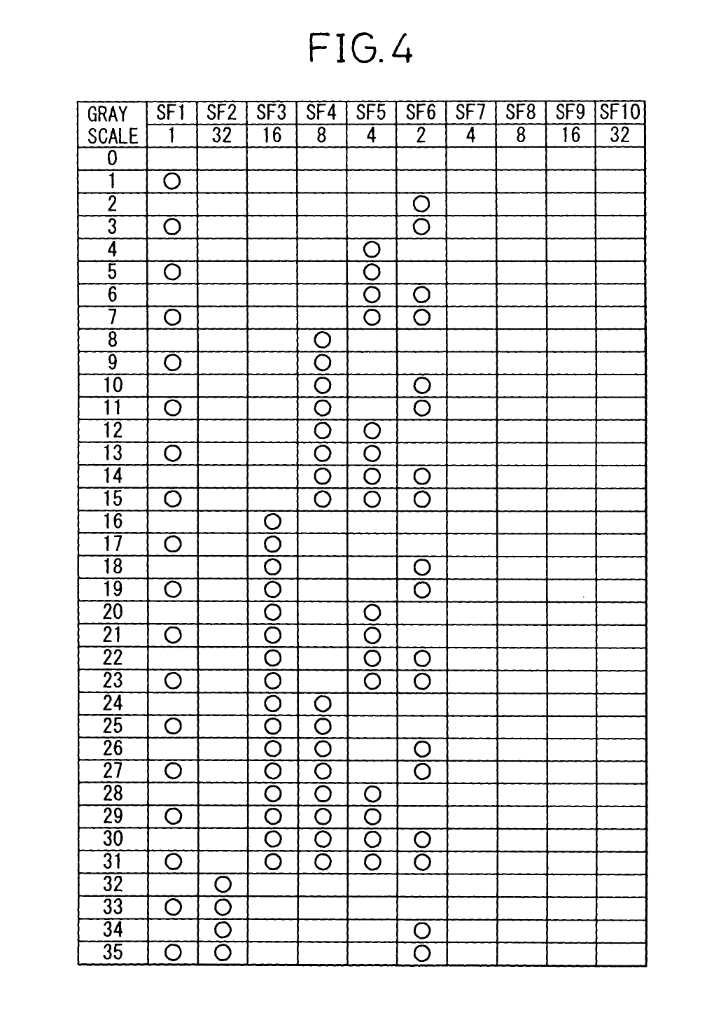

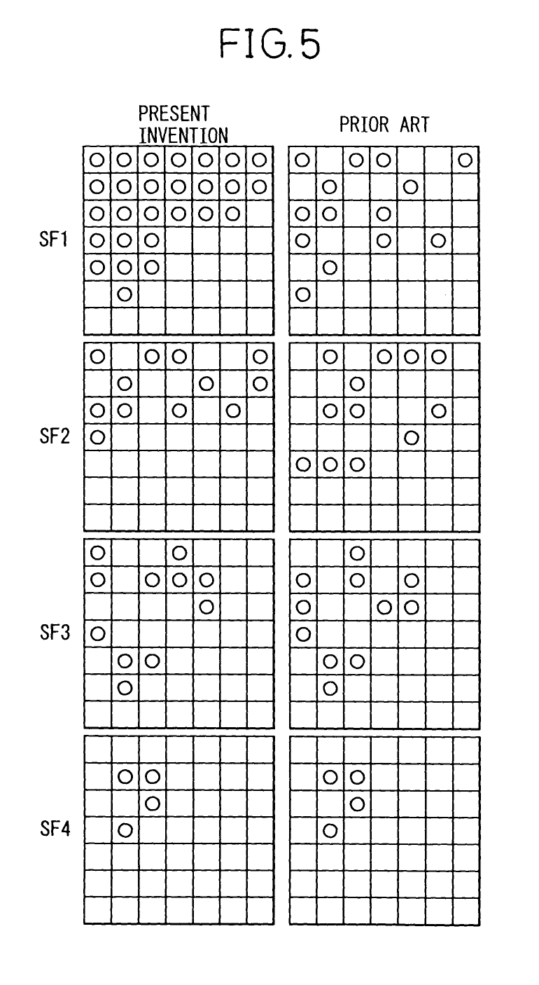

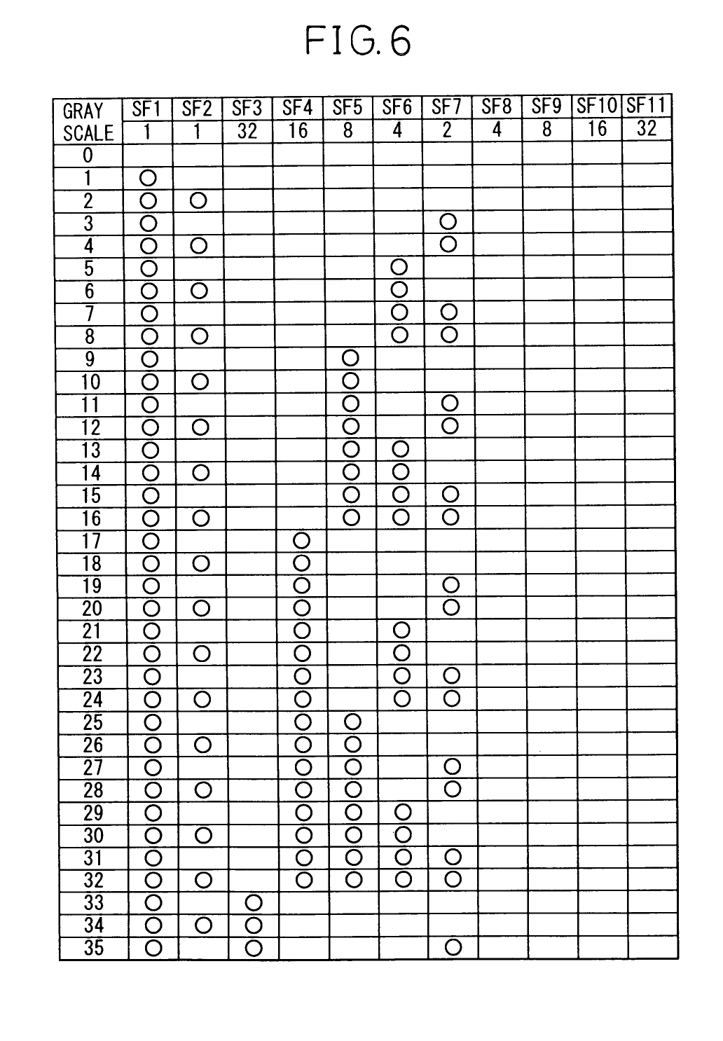

FIG. 6 is a diagram that shows the configuration of subfields and the combination that realizes the gradation level in the PDP device in the first embodiment of the present invention. Although only the gradation levels from 0 to 35 are shown here, it is possible to realize the gradation levels from 0 to 124 with this configuration. As is obvious by comparison with FIG. 4, the configuration of subfields in the first embodiment differs from that in the conventional case in that a subfield with luminance ratio 1 is added at the head of the subfield configuration. Therefore, there are provided, as a result, two subfields with luminance ratio 1. The second subfield SF2 with luminance ratio 1 can be arranged in another position.

As shown schematically, the subfield SF1 at the head is lit when any gradation level equal to 1 or higher is displayed. Even though SF1 is always lit as described above, it is possible to display any gradation level because there are two subfields with luminance ratio 1. In the conventional case, SF1 is lit only when an odd-numbered gradation level is displayed, and SF1 is not lit when an even-numbered gradation level is displayed. Contrary to this, it is possible, in the present embodiment, to light SF1 at the head when an odd-numbered gradation level is displayed as similar to the conventional case and always to light SF1 when an even-numbered gradation level is displayed by the combination with SF2 with luminance ratio 1 for display. For example, when the gradation level 2 is displayed, both SF1 and SF2 are lit and when the gradation level 4 is displayed, SF1, SF2 and SF7 (luminance ratio 2) are lit. Moreover, when the gradation level 32 is displayed, SF1, SF2 and SF4 to SF7 are lit. Therefore, all of the cells that are to be lit in SF2 and subsequent subfields are only those that are lit in SF1.

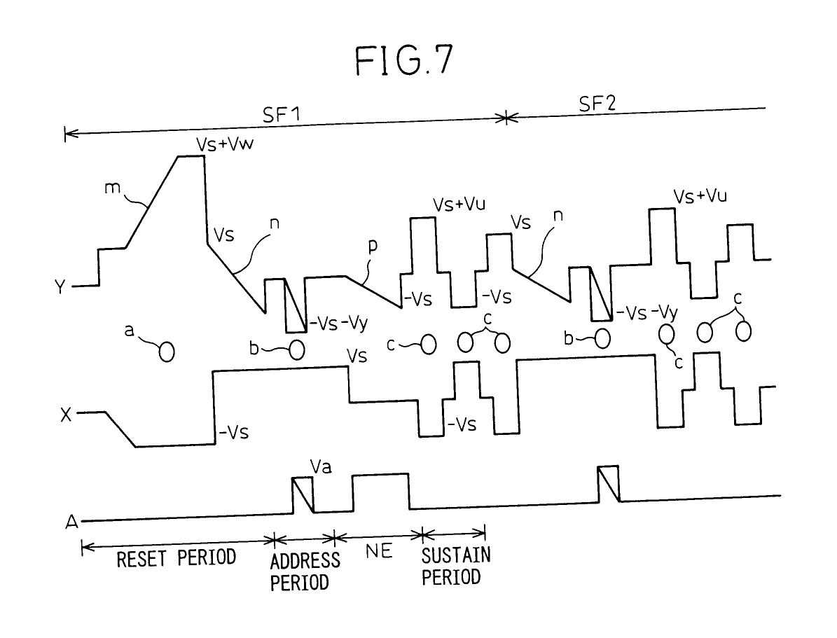

FIG. 7 is a diagram that shows the drive waveforms in SF1 and SF2 and subsequent subfields in the first embodiment. In SF1, as shown schematically, the reset period is provided, as is similar to the conventional case shown in FIG. 3, and the all-cell write discharge (reset discharge) is caused to occur, then the inclined wave-shaped charge control pulse is applied for the adjustment of wall charges. Subsequently to this, an address discharge is caused to occur in a cell to be lit in the address period and wall charges necessary for the sustain discharge are formed. Moreover, during a period NE, in a state in which 0V is being applied to the X electrode and Va is being applied to the address electrode, an inclined waveform p, the voltage of which varies from 0V to −Vs, is applied to the Y electrode, and the quantity of wall charges in an unselected cell are adjusted to a proper value. Then, Vs and −Vs are applied alternately to the Y electrode and the X electrode during the sustain period and a sustain discharge is caused to occur (the first pulse is Vs+vu).

In SF2, the all-cell write discharge, which has been caused to occur in SF1 during the sustain period, is not caused to occur, but only the inclined wave-shaped charge control pulse is applied and the period NE is not provided. The subsequent subfields are the same as SF2 only with exception of the length of the sustain period.

By using these drive waveforms, it is possible to cause an address discharge to occur even if a write discharge is not caused to occur, because all of the cells to be lit in SF2 and subsequent subfields have been lit in SF1 and have wall charges formed by the sustain discharge in SF1. Therefore, the number of times of write discharges (reset discharge) is reduced and the contrast is improved.

Moreover, in SF2 and subsequent subfields, as the address discharge is caused to occur by using the wall charges formed by the sustain discharge in SF1, it is not necessary to raise the voltage of the write discharge in SF1 greater than that required. As described above, in the conventional case where the all-cell write discharge is caused to occur in SF1, the time interval from the all-cell write discharge in SF1 until the address discharge is caused to occur in a subsequent subfield is lengthened, therefore, it is necessary to raise the voltage of the all-cell write discharge in SF1 to greater than that in the case where the all-cell write discharge is caused to occur in all of the subfields. Contrary to this, in the present embodiment, as the wall charges formed by the sustain discharge in SF1 are used, the voltage of the write discharge in SF1 can be almost equal to that in the case where the all-cell discharge is caused to occur in all of the subfields. Therefore, according to the present invention, the contrast ratio can be further improved compared to the conventional case where the all-cell write discharge is caused to occur in SF1.

In SF1, all of the cells to be lit in the display field are selected and the sustain discharge is caused to occur. Therefore, the cells not to be lit in SF1 are those not to be lit in the display field, and if the quantity of wall charges in the unlit cells are adjusted to a proper value, it is possible to suppress the mutual interference between cells and increase the operation margin because the possibility of the unlit cells to erroneously emit light in subsequent subfields is reduced. In concrete terms, all that has to be done is to prevent a discharge from occurring even if an address pulse and a scan pulse are applied to the unlit cells, that is, Va is applied to the address electrode during the period NE as described above, and the inclined waveform p, the voltage of which varies from 0V to −Vs is applied to the Y electrode. At this time, it is desirable to lower the finally reached potential of the waveform p than that of the inclined wave-shaped charge control pulse n.

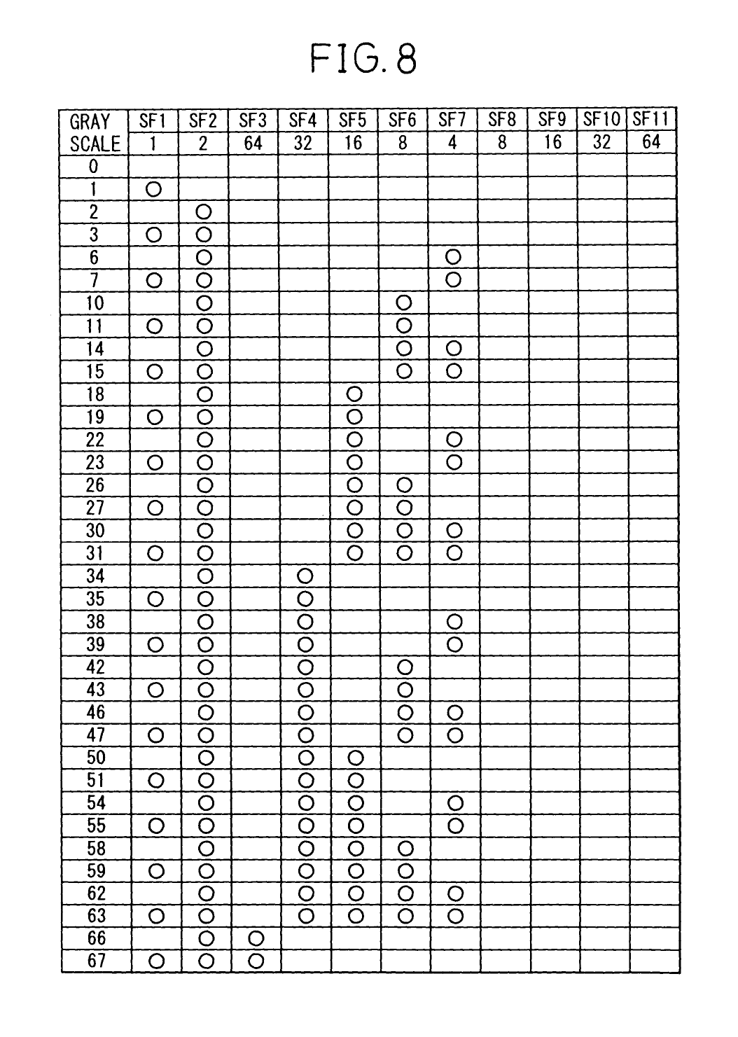

FIG. 8 is a diagram that shows the configuration of subfields and the combination of subfields to display gradation levels in the PDP device in the second embodiment of the present invention. Similar to FIG. 6, although only the gradation levels 0 to 67 are shown here, 0 to 247 gradation levels can be displayed with this configuration. However, some gradation levels cannot be displayed. As shown schematically, in the configuration of subfields in the second embodiment, there are 11 subfields, and SF1 has the lowest luminance ratio 1, SF2 has the luminance ratio 2, and the subfields having the luminance ratios 64, 32, 16, 8, 4, 8, 16, 32 and 64 are arranged in this order. As shown schematically, the second SF2 is lit when all of the gradation levels equal to 2 or higher are displayed. Therefore neither the gradation level 4 nor 5 can be displayed.

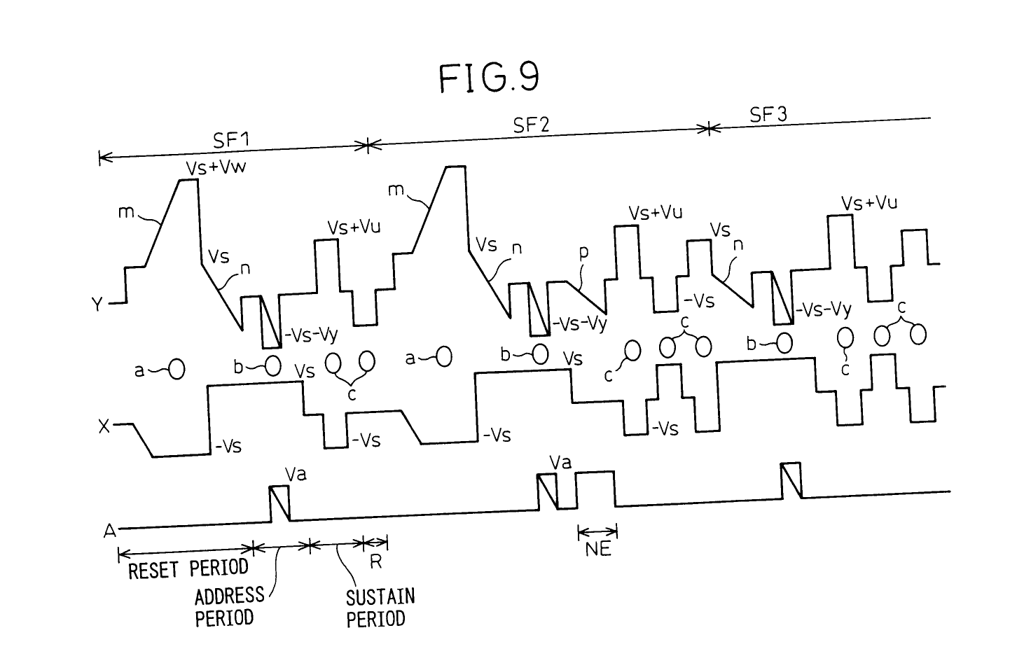

FIG. 9 is the diagram that shows the drive waveforms in SF1, SF2 and subsequent subfields in the second embodiment. As shown schematically, the waveforms in SF1 are provided with the reset period, the address period, the sustain period, and an SF reset period R. The reset period, the address period and the sustain period are the same as the drive waveforms in the conventional case shown in FIG. 3. In the SF reset period R, a negative pulse (−Vs) is applied to the Y electrode to erase the residual charges formed by the sustain discharge in the lit cells.

The drive waveforms in SF2 are the same as the drive waveforms in SF1 in the first embodiment and the drive waveforms in SF3 and subsequent subfields are the same as the drive waveforms in SF2 and subsequent subfields in the first embodiment.

In the second embodiment, all of the cells to be lit in a display field have been lit in SF2, therefore, it is not necessary to cause the all-cell write discharge to occur in SF3 and subsequent subfields as is similar to the first embodiment. In the second embodiment, the all-cell write discharge is caused to occur in SF1 and SF2, therefore, the contrast ratio is lowered accordingly but improved compared to the conventional case. As described above, it is possible for there to be various modifications of the present invention that will bring advantages, although there are some defects.

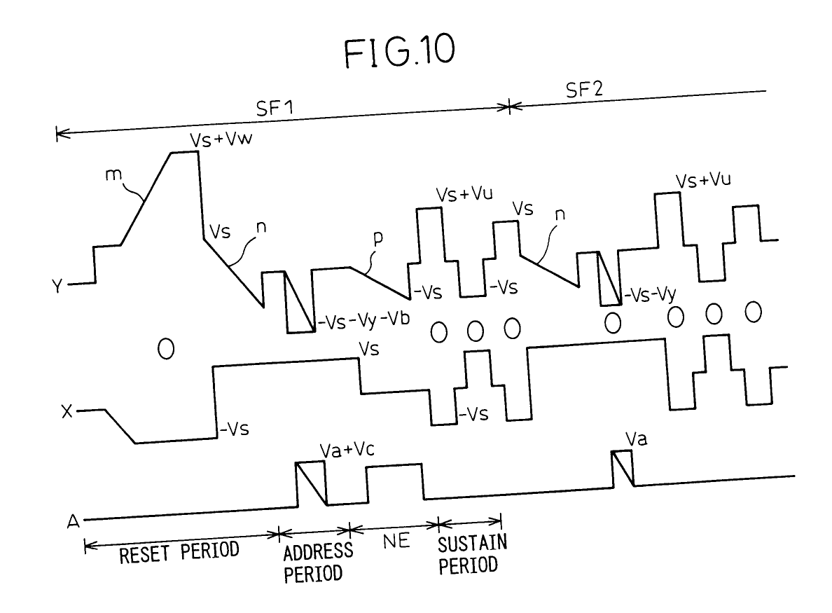

FIG. 10 is a diagram that shows an example of modification of the drive waveforms in the first embodiment in FIG. 6. In this example of modification, the width of the address pulse in SF1 is made to be wider than that in other subfields and the voltage of the address pulse is made to be greater than that in other subfields. Moreover, the width of the scan pulse in SF1 is made to be wider than that in other subfields and the voltage of the scan pulse is made to be greater than that in other subfields. Due to this, it is possible to certainly cause an address discharge to occur in a cell to be lit in SF1. In SF2 and subsequent subfields, the wall charges formed by the sustain discharge in SF1 are used and, therefore, the address discharge is certainly caused to occur even though the widths of the address pulse and the scan pulse are narrow and their voltages are low. Due to this, the address period in a display filed can be shortened as a whole.

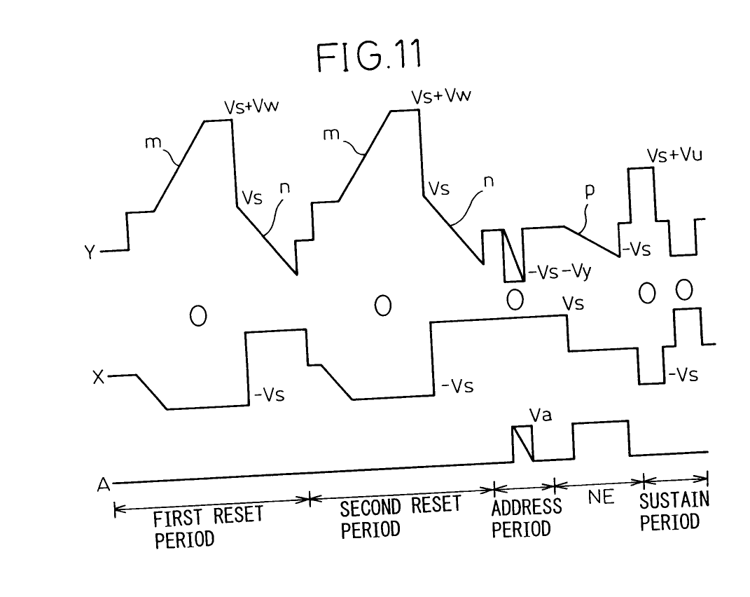

FIG. 11 is a diagram that shows another example of modification of the drive waveforms in the first embodiment in FIG. 6. In this example of modification, the all-cell write discharge is caused to occur twice successively and the inclined wave-shaped charge control pulse is applied twice successively in SF1. In other words, two reset periods are provided one after another contiguously. This means that the all-cell write discharge is caused to occur twice and the address discharge can be caused to occur in SF1 more certainly.

Although the embodiments described above are those in which the reset period is provided only in SF1 or only in SF1 and SF2, it is possible to further provide the reset period in a subfield with a large luminance ratio so that an address discharge can be caused to occur in the subfield more certainly.

As described above, according to the driving method of the present invention, it is possible to realize a PDP device of high display quality that never produces display errors or the like even if the number of times of all-cell write discharge is reduced to improve the contrast ratio.

We claim:

1. A method for driving a plasma display panel, wherein a display field, corresponding to a display of a screen, is composed of a plurality of subfields, a gradation display is realized by combining subfields to be lit among the plurality of subfields, each subfield comprises at least an address period to write cells to be lit in the subfield and a sustain period to cause light emission to occur in the written cells, and all of the cells to be lit in a display field are lit in a predetermined subfield among the plurality of subfields making up the display field.

2. A method for driving a plasma display panel, as set forth in claim 1, wherein the predetermined subfield is a subfield with the lowest luminance ratio.

3. A method for driving a plasma display panel, as set forth in claim 1, wherein a display field has a subfield with a same luminance ratio as that of the predetermined subfield, in addition to the predetermined subfield.

4. A method for driving a plasma display panel, as set forth in claim 1, wherein the predetermined subfield is the subfield at the head in a display field.

5. A method for driving a plasma display panel, as set forth in claim 1, wherein an all-cell write discharge is caused to occur in the predetermined subfield before the address period.

6. A method for driving a plasma display panel, as set forth in claim 1, wherein an all-cell write discharge is caused to occur in the predetermined subfield and a subfield with a heavy weight of luminance before the address period.

7. A method for driving a plasma display panel, as set forth in claim 5, wherein the all-cell write discharge is caused to occur twice successively in the predetermined subfield.

8. A method for driving a plasma display panel, as set forth in claim 5, wherein a subfield reset discharge is caused to occur in order to erase the residual charges in a lit cell in the subfield immediately before the subfield in which the all-cell write discharge is caused to occur.

9. A method for driving a plasma display panel, as set forth in claim 1, wherein the subfield with the lowest luminance ratio is arranged at the head in a display field and the predetermined subfield is arranged in the second position in the display field.

10. A method for driving a plasma display panel, as set forth in claim 9, wherein the predetermined subfield is one with the second lowest luminance ratio.

11. A method for driving a plasma display panel, as set forth in claim 9, wherein an all-cell write discharge is caused to occur in the subfield at the head and the predetermined subfield before the address period.

12. A method for driving a plasma display panel, as set forth in claim 9, wherein a subfield reset discharge is caused to occur in order to erase the residual charges in a lit cell in the subfield at the head.

13. A method for driving a plasma display panel, as set forth in claim 1, wherein the widths of an address pulse and a scan pulse during the address period in the predetermined subfield are wider than those of the address pulse and the scan pulse during the address period in other subfields.

14. A method for driving a plasma display panel, as set forth in claim 1, wherein the voltage of an address pulse during the address period in the predetermined subfield is greater than that of the address pulse during the address period in other subfields.

15. A method for driving a plasma display panel, as set forth in claim 1, wherein the voltage of a scan pulse during the address period in the predetermined subfield is greater than that of the scan pulse during the address period in other subfields.

16. A method for driving a plasma display panel, as set forth in claim 1, wherein a process to suppress a discharge in an unlit cell is performed between the address period and the sustain period in the predetermined subfield.

17. A method for driving a plasma display panel, as set forth in claim 16, wherein the process to suppress a discharge in an unlit cell is a process in which, at the same time an address pulse is applied to an address electrode, a pulse, the applied voltage of which varies as time elapses, is applied to a scan electrode.

18. A method for driving a plasma display panel, as set forth in claim 17, wherein the final potential of the pulse, the applied voltage of which varies as time elapses, is lower than the finally reached potential of a charge control pulse, which is applied after an all-cell write discharge and the applied voltage of which varies as time elapses.

19. A method for driving a plasma display panel, as set forth in claim 1, wherein the gradation display level is determined with the luminance due to lighting in the predetermined subfield being taken into consideration.

20. A plasma display device comprising a plasma display panel and a driving circuit for the plasma display panel, wherein the driving circuit drives the plasma display panel using the driving methods set forth in claim 1.
